(19) United States
(12) Patent Application Publication
(10) Pub. No.: US 2025/0023951 A1
(43) Pub. Date: Jan. 16, 2025

(54) METHOD AND APPARATUS FOR HANDLING OF PDU SESSION FOR LADN DNN IN A WIRELESS COMMUNICATION SYSTEM

(71) Applicant: SAMSUNG ELECTRONICS CO., LTD., Suwon-si (KR)

(72) Inventors: Ashok Kumar NAYAK, Bangalore (IN); Lalith KUMAR, Bangalore (IN)

(21) Appl. No.: 18/770,362

(22) Filed: Jul. 11, 2024

(30) Foreign Application Priority Data
Jul. 14, 2023 (IN) 202341047690
Sep. 27, 2023 (IN) 202341064772
Jun. 28, 2024 (IN) 202341047690

(51) Int. Cl. H04L 67/143; H04W 48/18; H04W 76/30; H04W 84/12

(52) U.S. Cl. CPC H04L 67/143; H04W 48/18; H04W 76/30; H04W 84/12

(57) ABSTRACT

The disclosure relates to a 5G or 6G communication system for supporting a higher data transmission rate. A method performed by an AMF entity in a wireless communication system, the method comprising: identifying whether a first LADN service area for a DNN and S-NSSAI is removed, and transmitting, to a SMF entity, a message for requesting a release of an ongoing PDU session subjected to an LADN in case that the first LADN service area is removed.

### CROSS-REFERENCE TO RELATED APPLICATIONS

This application is based on and claims priority under 35 U.S.C. § 119 to Indian Partial Patent Application No. 202341047690 filed on Jul. 14, 2023, Indian Partial Patent Application No. 202341064772 filed on Sep. 27, 2023, and Indian Complete Patent Application No. 202341047690 filed on Jun. 28, 2024, in the Indian Intellectual Property Office, the disclosure of which are incorporated by reference herein in their entirety.

### BACKGROUND

### 1. Field

The disclosure generally relates to the field of wireless communication. More particularly, the disclosure relates to a terminal and a communication method thereof in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The principal object of the embodiments herein is to disclose user equipment (UE) and methods for handling at least one protocol data unit (PDU) session in 3GPP networks.

Another object of the embodiment herein is to disclose the UE and methods for ensuring that the access and mobility management function (AMF) and session management function (SMF), along with the UE, are correctly handling the protocol data session for LADN per data network name (DNN), single network slice selection assistance information (S-NSSAI) and service area (SA) in 3GPP networks.

Another object of the embodiments herein is to disclose the UE and methods for updating the extended LADN information using a UE configuration update procedure received from the AMF, comprising one of, addition and removal of the at least one associated set of DNN, S-NSSAI and SA for ongoing PDU session.

Another object of the embodiment herein is to disclose the UE and methods for determining one of, keeping the ongoing PDU session, and releasing the ongoing PDU session locally based on the received update from the UE configuration update procedure.

Another object of the embodiment herein is to disclose the UE and methods for triggering the release of the ongoing PDU session locally and sending a request to the SMF to release the PDU session.

### SUMMARY

Accordingly, the embodiments herein provide methods for handling at least one protocol data unit (PDU) session in a wireless network. The method discloses identifying, by an access and mobility management function (AMF), an update to at least one extended local area data network (LADN) information for the at least one ongoing PDU session. The method further discloses determining, by the AMF, the identified update to the at least one extended LADN information comprises one of, addition and removal of at least one associated set of data network name (DNN), single network slice selection assistance information (S-NSSAI) and service area (SA) for the at least one ongoing PDU session. The method further discloses sending, by the AMF, a service operation message to a session management function (SMF) based on the determined update to release the at least one ongoing PDU session along with a release indication, wherein the release indication indicates one of, addition and removal of the at least one associated set of DNN, S-NSSAI and SA for the at least one ongoing PDU session.

Accordingly, the embodiments herein provide an access and mobility management function (AMF) for handing at least one protocol data unit (PDU) session in a wireless network. The AMF comprises a PDU session handler, coupled with a processor and a memory. The PDU session handler is configured to identify an update to at least one extended local area data network (LADN) information for the at least one ongoing PDU session. The PDU session handler is further configured to determine the identified update to the at least one extended LADN information comprises one of, addition and removal of at least one associated set of data network name (DNN), single network slice selection assistance information (S-NSSAI) and LADN service area (SA) for the at least one ongoing PDU session. The PDU session handler is further configured to send a service operation message to a session management function (SMF) based on the determined update to release the at least one ongoing PDU session along with a release indication, wherein the release indication indicates one of, addition and removal of the at least one associated set of DNN, S-NSSAI and LADN SA for the at least one ongoing PDU session.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 illustrates a scenario of an SMF that is not aware of LADN DNN status that a PDU needs to be treated as the LADN DNN according to embodiments as disclosed herein;

FIG. 2 illustrates a scenario when the SMF is not aware of LADN DNN status that a PDU is no longer the LADN DNN and to be treated as normal DNN according to embodiments as disclosed herein;

FIG. 3 illustrates a scenario when the SMF is aware of the LADN DNN status and the PDU is the LADN DNN according to the embodiments as disclosed herein;

FIG. 4 illustrates a scenario when the SMF is aware of the LADN DNN status and that the PDU is a normal DNN according to embodiments as disclosed herein;

FIG. 5 illustrates an overview of a 3GPP network for handling the PDU session according to embodiments as disclosed herein;

FIG. 6 illustrates various hardware components of a UE according to embodiments as disclosed herein;

FIG. 7 illustrates various hardware components of an AMF according to embodiments as disclosed herein;

FIG. 8 illustrates a sequence diagram of a method for handling the LADN PDU session in the wireless network according to embodiments as disclosed herein;

FIG. 9 illustrates a flowchart of a method for handling the PDU session by the AMF in the wireless network according to embodiments as disclosed herein;

FIG. 10 illustrates a flowchart of a method for handling the PDU session by the SMF in the wireless network according to embodiments as disclosed herein;

FIG. 11 illustrates various hardware components of a network entity according to embodiments as disclosed herein;

FIG. 12 illustrates various hardware components of a UE according to embodiments as disclosed herein; and

FIG. 13 illustrates various hardware components of a base station according to embodiments as disclosed herein.

### DETAILED DESCRIPTION

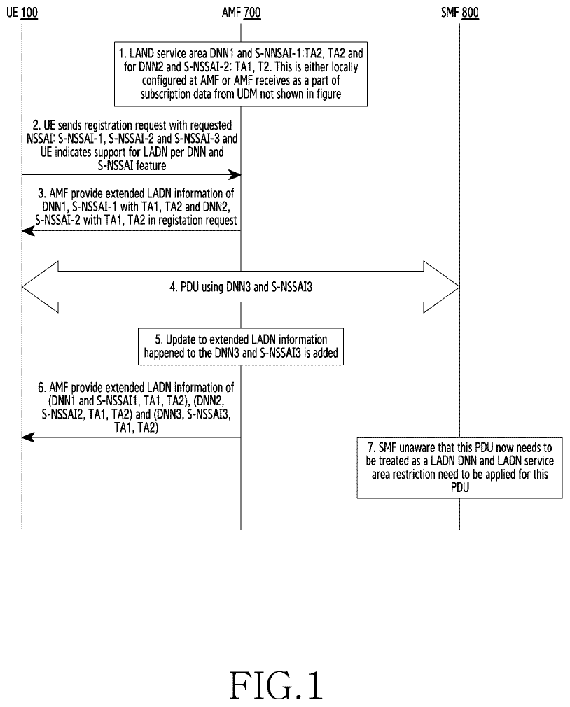

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising,” “having” and “including” are to be construed as open-ended terms unless otherwise noted.

The words/phrases “exemplary,” “example,” “illustration,” “in an instance,” “and the like,” “and so on,” “etc.,” “etcetera,” “e.g.,”, “i.e.,” are merely used herein to mean “serving as an example, instance, or illustration.” Any embodiment or implementation of the present subject matter described herein using the words/phrases “exemplary,” “example,” “illustration,” “in an instance,” “and the like,” “and so on,” “etc.,” “etcetera,” “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

Embodiments disclosed herein relate to afield of local area data network (LADN) in 3rd generation partnership project (3GPP) networks, and more particularly to a user equipment (UE) and methods for ensuring that the access and mobility management function (AMF) and session management function (SMF) along with the UE are correctly handling the protocol data session for LADN per data network name (DNN), single network slice selection assistance information (S-NSSAI), and service area (SA) in 3GPP networks.

Access to a data network via a protocol data unit (PDU) session for a local area data network (LADN) is only available in a specific LADN service area. The LADN service area can be considered to be a set of tracking areas (TAs). The LADN is a service provided by a serving PLMN. A user equipment (UE) is configured to know whether a particular data network name (DNN) is LADN DNN or if the UE gets this information from an access and mobility management function (AMF) during the registration and UE configuration update procedure. The UE initiates PDU sessions related to LADN DNN only when the UE is inside the LADN service area. Similarly, a session management function (SMF) ensures that a downlink packet is not provided to the UE when the UE is outside of the LADN service area. To know whether the UE is inside or outside of the LADN service area, the SMF subscribes to the “UE mobility event notification” service provided by the AMF for reporting UE presence in an area of interest by providing the LADN DNN. The details are provided in TS 23.501 extended this LADN concept from per DNN to per DNN and single-network slice selection assistance information (S-NSSAI). The details are provided in TS 23.501.

3GPP has provided a solution for configuring the LADN per DNN and S-NSSAI. If the UE has indicated its capability to support LADN per DNN and S-NSSAI, then the AMF provides the LADN service area (if it is locally configured at AMF or received as part of the subscription data from unified data management (UDM)). During the PDU session establishment, the AMF provides an indication that the PDU session is subject to LADN per LADN DNN and S-NSSAI to the SMF. Then, the SMF configures the DNN of the PDU session as LADN DNN and subscribes to “UE mobility event notification” for reporting the presence of the UE in an area of interest by providing LADN DNN and S-NSSAI to the AMF.

In a scenario, where there is an update happens to extended LADN information either in UDM and the AMF gets a notification from UDM or the update happens to extended LADN information that was locally configured at AMF, then the AMF triggers a UE configuration update procedure for the UE. The update can happen to either the LADN service area, DNN and S-NSSAI, or both. The update can be one of, the additions of DNN and S-NSSAI or LADN service area or both and the removal of DNN and S-NSSAI or LADN service area or both from this extended LADN information.

FIG. 1 illustrates a scenario of SMF 800 not being aware of LADN DNN status that a protocol data unit (PDU) needs to be treated as the LADN DNN. Referring to FIG. 1, 3GPP has provided solution of configuring the LADN per DNN and S-NSSAI. If the UE 100 has indicated its capability to support LADN per DNN and S-NSSAI, then the AMF 700 provides extended LADN information which includes LADN service area, DNN and S-NSSAI if it is locally configured at the AMF 700 or received as part of the subscription data from the UDM. During PDU session establishment, the AMF 700 provides one indication that the PDU Session is subject to LADN per LADN DNN and S-NSSAI to the SMF 800. Then, the SMF 800 configures the DNN of PDU Session as LADN DNN and subscribes to “UE mobility event notification” for reporting UE 100 presence in area of interest by providing LADN DNN and S-NSSAI to the AMF 700.

In a scenario, when the extended LADN information is updated, either in the UDM and the AMF 700 gets a notification from the UDM, or to the extended LADN information which was locally configured at the AMF 700 then the AMF 700 triggers a UE configuration update procedure to the UE 100. The update can happen to either LADN service area or DNN and S-NSSAI or both and the update can be addition of DNN and S-NSSAI or LADN service area or both to this extended LADN information. If the update is addition, then it is possible that there can be one PDU session already established by the UE 100 which would have treated as a normal PDU session. But after this extended LADN information update, the SMF 800 may not be aware of the update because of which the UE still treats this as a normal PDU session which means all the downlink packet may be sent to the UE 100 even if the UE 100 is outside of LADN service area configured per DNN & S-NSSAI which is incorrect.

At step 1, the UE 100 sends a registration request with S-NSSAI1, S-NSSAI2, and S-NSSAI3 and indicates support for LADN per DNN and S-NSSAI. At step 2, the AMF 700 is configured as DNN1, and S-NSSAI 1 and DNN2, and S-NSSAI2 as LADN DNN per DNN and S-NSSAI. LADN service areas TA1 and TA2 are configured locally at AMF 700 or may be received from UDM for both LADNs. At step 3, the AMF 700 provides the UE 100 the extended LADN information: DNN1 and S-NSSAI1, TA1, TA2, and DNN2, S-NSSAI2, TA1, TA2. At step 4, the UE 100 has one established PDU session (PDU1), which is done using DNN3 and S-NSSAI3. At step 5, an update to extended LADN information like DNN3 and S-NSSAI3 is added. At step 6, the AMF 700 provides updated extended LADN information to the UE 100 using the UE configuration update procedure: (DNN1 and S-NSSAI1, TA1, TA2), (DNN2, S-NSSAI2, TA1, TA2), and (DNN3, S-NSSAI3, TA1, TA2). At step 7, the SMF 800 is still not aware of this update, because of this, the SMF 800 still considers this PDU1 as a normal PDU session and is not applying LADN service area restrictions (e.g., blocking downlink packets when UE 100 is outside of the LADN service area configured per DNN and S-NSSAI).

In another scenario, if the UE 100 moves out of the LADN service area per DNN and S-NSSAI, the SMF 800 still considers the existing PDU (which has been already established using the same LADN DNN and S-NSSAI) as LADN DNN per DNN and S-NSSAI, which may lead to the release of this PDU or the deactivation of this PDU, which is not correct. If the PDU session is retained, then the AMF 700 continues to send the UE 100 mobility event notification for the area of interest that was subscribed by the SMF 800 during the PDU session establishment by providing LADN DNN and S-NSSAI.

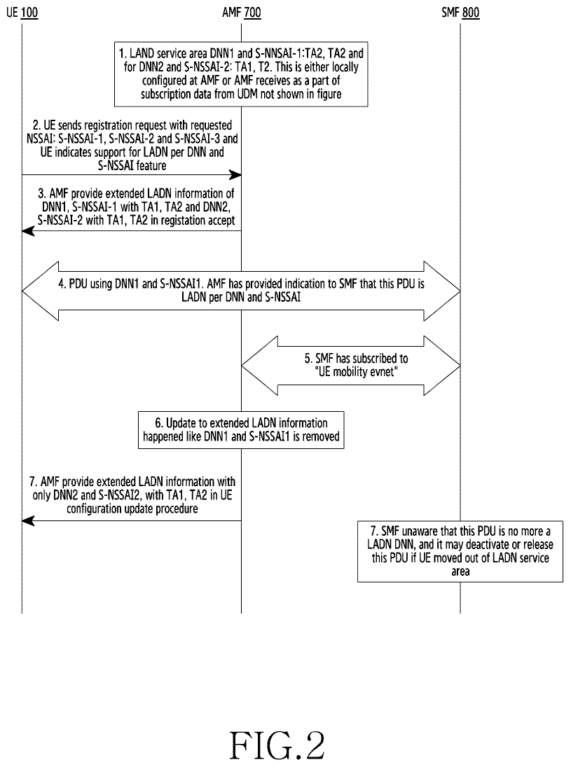

FIG. 2 illustrates a scenario when the SMF 800 is not aware of the LADN DNN status and that the PDU is no longer the LADN DNN. In step 1, the AMF 700 is configured as DNN1, S-NSSAI1, and DNN2, and S-NSSAI2 as LADN DNN per DNN and S-NSSAI. LADN service areas TA1 and TA2 are configured locally at the AMF 700 or may be received from the UDM for both LADNs. In step 2, the UE 100 sends a registration request with S-NSSAI1, S-NSSAI2, and S-NSSAI3 and indicates the support for LADN per DNN and S-NSSAI. The LADN service areas TA1 and TA2 are configured locally at AMF 700 or may be received from the UDM for both LADNs. In step 3, the AMF 700 provides the UE 100 with the extended LADN information: DNN1 and S-NSSAI1, TA1, TA2, and DNN2, S-NSSAI2, TA1, TA2. In step 4, the UE 100 has one established PDU session (PDU1), which is done using DNN1 and S-NSSAI1. In step 5, the SMF 800 has subscribed to “UE mobility event notification” for reporting the presence of the UE 100 in the area of interest by providing LADN DNN1 and S-NSSAI1 to the AMF 700. In step 6, consider that there has been an update to extended LADN, wherein information like DNN1 and S-NSSAI1 is removed. In step 7, the AMF 700 provides the updated extended LADN information to the UE 100 using the UE configuration update procedure: DNN2, S-NSSAI2, TA1, TA2. In step 8, the SMF 800 is still not aware of this update, because of this, the SMF 800 still considers this PDU1 as LADN DNN, and the SMF may release or deactivate this PDU if the UE 100 moves out of the LADN service area.

Also, the subscription that SMF 800 subscribed to the AMF 700 for “UE mobility event notification” for LADN DNN and the S-NSSAI is a waste as the AMF 700 continues to send reports that are not relevant. In an example herein, the LADN service areas TA1 and TA2 have been kept the same for both LADN per DNN1, S-NSSAI1, and DNN2, S-NSSAI2, but they can be different as well.

Hence, there is a need in the art for solutions that will overcome the above-mentioned drawback(s), among others.

The embodiments herein disclose a user equipment (UE) and methods for handling existing protocol data unit (PDU) sessions upon local area data network (LADN) information updates. Embodiments herein disclose the UE and methods for ensuring that an access and mobility management function (AMF) and the session management function (SMF), along with the UE, are correctly handling the protocol data session for LADN per data network name (DNN), single network slice selection assistance information (S-NSSAI), and service area (SA) in 3GPP networks.

Embodiments disclosed herein include procedures for handling existing PDU sessions upon extended LADN information updates. The method includes the UE sending a registration request with S-NSSAI1, S-NSSAI2, and S-NSSAI3 and indicates the support for LADN per DNN, S-NSSAI. The AMF 700 is configured as DNN1, and S-NSSAI 1 and DNN2, and S-NSSAI2 as LADN DNN per DNN and S-NSSAI. A LADN service area TA1, TA2 is configured locally at the AMF 700 or may be received from the unified data management (UDM) for both LADN. The AMF 700 provides the extended LADN information (comprising of, but not limited to, DNN1 and S-NSSAI1, TA1, TA2, and DNN2, S-NSSAI2, TA1, TA2) to the UE 100. The UE 100 has an established PDU session (PDU1), which is done using DNN3 and S-NSSAI3. Consider that there is an update to the extended LADN information, like the addition of DNN3 and S-NSSAI3. The AMF 700 provides the updated extended LADN information to the UE 100 using the UE configuration update procedure: (DNN1 and S-NSSAI1, TA1, TA2), (DNN2, and S-NSSAI2, TA1, TA2), and (DNN3, and S-NSSAI3, TA1, TA2). The AMF 700 sends the Nsmf_PDUSession_UpdateSMContext service operation and indicates that the PDU is subjected to the LADN per DNN and S-NSSAI or that the PDU is subjected to the LADN per DNN and S-NSSAI is enabled. Based on the received indication, the SMF 800 considers or marks the PDU as LADN DNN. The SMF 800 subscribes to the AMF 700 to the “UE mobility event notification” service by sending Namf_EventExposure_Subscribe service operation.

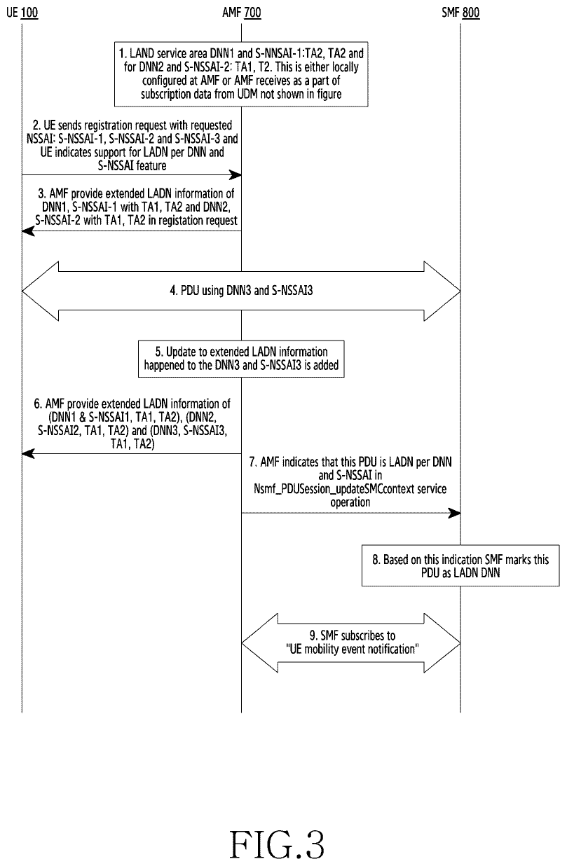

Referring now to the drawings, and more particularly to FIGS. 3 through 10, where similar reference characters denote corresponding features consistently throughout the figures, there are shown preferred embodiments.

FIG. 3 illustrates a scenario when the SMF 800 is aware of the LADN DNN status and that the PDU is the LADN DNN. When there is an update to extended LADN information (such as, but not limited to, the addition of one DNN and S-NSSAI or LADN service area or both), the AMF 700 indicates in Nsmf_PDUSession_UpdateSMContext service operation to the SMF 800 that this PDU is subjected to LADN per DNN and S-NSSAI or that this PDU is subjected to LADN per DNN and S-NSSAI is enabled. Based on this indication, the SMF 800 considers or marks this PDU as LADN DNN. The SMF 800 subscribes to the AMF 700 “UE mobility event notification” service as well. The UE 100 considers or marks this as LADN DNN based on the update received in the UE configuration update procedure because associated LADN DNN and S-NSSAI are added to the extended LADN information. The UE 100 may decide to keep or release the PDU, and similarly, based on the operator policy, the SMF 800 may also decide to keep or release the PDU.

Referring to FIG. 3, at step 1, the UE 100 sends a registration request with S-NSSAI1, S-NSSAI2, and S-NSSAI3 and indicates the support for LADN per DNN and S-NSSAI. At step 2, the AMF 700 is configured as DNN1, and S-NSSAI1 and DNN2 and S-NSSAI2 as LADN DNN per DNN and S-NSSAI. The LADN service areas TA1 and TA2 are configured locally at the AMF 700 or may be received from the UDM for both LADNs. At step 3, the AMF 700 provides the UE 100 with the extended LADN information: DNN1 and S-NSSAI1, TA1, TA2, and DNN2, S-NSSAI2, TA1, TA2. At step 4, consider that the UE 100 has one established PDU session (PDU1), which is done using DNN3 and S-NSSAI3. At step 5, an update to the extended LADN information, such as DNN3 and S-NSSAI3, is added. At step 6, the AMF 700 provides the updated extended LADN information to the UE 100 using the UE configuration update procedure: (DNN1 and S-NSSAI1, TA1, TA2), (DNN2, S-NSSAI2, TA1, TA2), and (DNN3, S-NSSAI3, TA1, TA2). At step 7, the AMF 700 sends the Nsmf_PDUSession_UpdateSMContext service operation to the SMF 800 and indicates that this PDU is subjected to LADN per DNN and S-NSSAI or that this PDU is subjected to LADN per DNN and S-NSSAI is enabled. At step 8, based on the received indication, the SMF 800 considers or marks the PDU as LADN DNN. At step 9, the SMF 800 subscribes to the AMF 700, the “UE mobility event notification” service, by sending a Namf_EventExposure_Subscribe service operation.

In an embodiment shown herein, when there is any update to extended LADN information (such as, but not limited to, one DNN and S-NSSAI being added), then the AMF 700 indicates in the Nsmf_PDUSession_UpdateSMContext service operation to the SMF 800 that this PDU is subjected to LADN per DNN and S-NSSAI or that this PDU subjected to LADN per DNN and S-NSSAI is enabled for the existing PDU session of associated DNN and S-NSSAI.

In an embodiment shown herein, the SMF 800 considers or marks this PDU as LADN DNN based on the indication received from the AMF 700 in Nsmf_PDUSession_UpdateSMContext service operation.

In an embodiment shown herein, the SMF 800 may keep this PDU session and subscribe to the AMF 700 to the “UE mobility event notification” service by sending Namf_EventExposure_Subscribe service operation.

In an embodiment shown herein, the UE 100 considers or marks this as LADN DNN based on the update received in the UE configuration update procedure because associated LADN DNN and S-NSSAI are added from the extended LADN information. The UE 100 may decide to keep or release the PDU session.

In an embodiment shown herein, on receiving Nsmf_PDUSession_UpdateSMContext service operation from the AMF 700 that the PDU is subjected to LADN per DNN and S-NSSAI or this PDU subjected to LADN per DNN and S-NSSAI is enabled for the existing PDU session of associated DNN and S-NSSAI, the SMF 800 may decide to keep or release the PDU based on the operator policy.

Embodiments herein use the Nsmf_PDUSession_UpdateSMContext service operation merely as an example of a message or service operation. It can be obvious to a person of ordinary skill in the art that the AMF 700 can use any other suitable message or service operation to indicate the information/indication that the respective PDU session/DNN is LADN DNN.

In an embodiment shown herein, based on a message or service operation (which indicates that the respective PDU session/DNN is LADN DNN), the AMF 700 indicates that the respective PDU session/DNN is LADN DNN and illustrates that the SMF 800 releases the PDU session, but this can be any network function (NF) in the network. For example, on determining that respective PDU session is a LADN DNN can trigger the release of the PDU session (e.g., by setting PDU sessions status information element (IE) as INACTIVE), the AMF 700 can make the UE 100 to release the PDU session or requesting the SMF 800 to release the PDU session by invoking respective service operation (for example, Nsmf_PDUSession_release), which makes the SMF 800 release the PDU session.

When there is any update to the extended LADN information (like the removal of one DNN and S-NSSAI), embodiments herein disclose that the AMF 700 indicates in a Nsmf_PDUSession_UpdateSMContext service operation to the SMF 800 that this PDU is not subjected to LADN per DNN and S-NSSAI. Based on this indication, the SMF 800 considers or marks this PDU as a normal DNN and not a LADN DNN. Also, the SMF 800 unsubscribes from the AMF 700, the “UE mobility event notification” service. The UE 100 considers or marks this as a normal DNN and not LADN DNN, based on the update received in the UE configuration update procedure, because the associated LADN DNN and S-NSSAI are removed from the extended LADN information. The UE 100 may decide to keep or release the PDU, and similarly, based on the operator policy, the SMF 800 may also decide to keep or release the PDU.

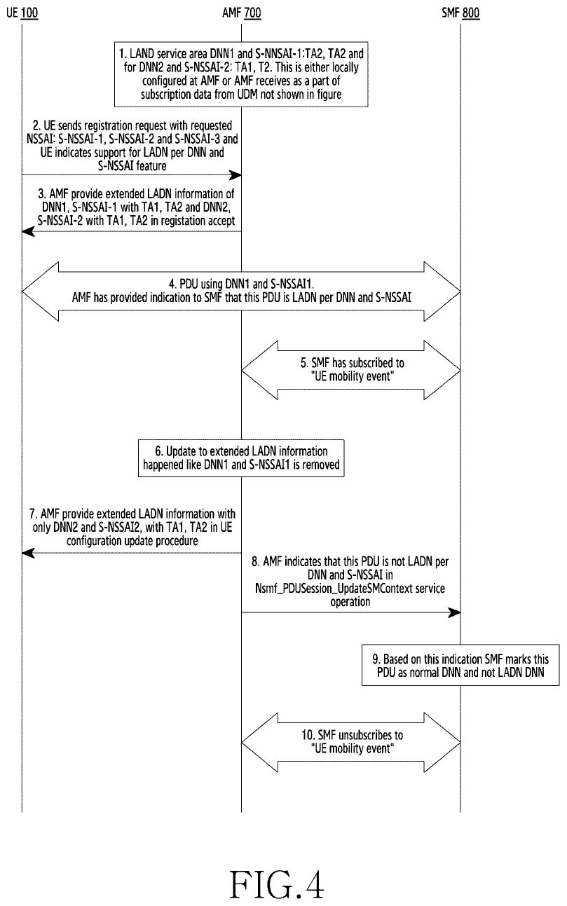

FIG. 4 illustrates a scenario when the SMF 800 is aware of the LADN DNN status and that the PDU is a normal DNN. In step 1, the AMF 700 is configured as DNN1, and S-NSSAI 1 and DNN2, and S-NSSAI2 as LADN DNN per DNN and S-NSSAI. LADN service areas TA1 and TA2 are configured locally at the AMF 700 or may be received from the UDM for both LADNs. In step 2, the UE 100 sends a registration request with S-NSSAI1, S-NSSAI2, and S-NSSAI3 and indicates the support for LADN per DNN and S-NSSAI. In step 3, the AMF 700 provides the UE 100 with the extended LADN information: DNN1 and S-NSSAI1, TA1, TA2, and DNN2, S-NSSAI2, TA1, TA2. In step 4, the UE 100 has an established PDU session (PDU1), which can be done using DNN1 and S-NSSAI1. In step 5, consider that the SMF 800 has subscribed to the “UE mobility event notification” for reporting the presence of the UE 100 in the Area of Interest by providing LADN DNN1 and S-NSSAI1 to the AMF 700. In step 6, consider that there has been an update to the extended LADN information (for example, the update can comprise removing the DNN1 and S-NSSAI1). In step 7, the AMF 700 provides the updated Extended LADN information to the UE 100 using a UE configuration update procedure: DNN2, S-NSSAI2, TA1, TA2. In step 8, the AMF 700 sends a Nsmf_PDUSession_UpdateSMContext service operation and indicates that this PDU is not subjected to LADN per DNN and S-NSSAI. In step 9, based on this received indication, the SMF 800 considers or marks this PDU as a normal DNN and not a LADN DNN. In step 10, the SMF 800 unsubscribes the AMF 700 from the “UE mobility event notification” service by sending a Namf_EventExposure_UnSubscribe service operation. In an example herein, the LADN service areas TA1 and TA2 have been kept the same for both LADN per DNN1, S-NSSAI1, and DNN2, S-NSSAI2, but they can be different as well.

In an embodiment shown herein, when there is an update to the extended LADN information (such as removing one DNN and S-NSSAI), the AMF 700 indicates in the Nsmf_PDUSession_UpdateSMContext service operation to the SMF 800 that this PDU is not subjected to LADN per DNN and S-NSSAI for the existing PDU session of the associated DNN and S-NSSAI.

In an embodiment shown herein, the SMF 800 considers or marks this PDU as a normal DNN and not a LADN DNN, based on the indication received from the AMF 700 in the Nsmf_PDUSession_UpdateSMContext service operation.

In an embodiment shown herein, the SMF 800 may keep this PDU session and unsubscribe the AMF 700 from the “UE mobility event notification” service by sending a Namf_EventExposure_UnSubscribe service operation.

In an embodiment shown herein, based on the update received in the UE configuration update procedure, the UE 100 considers or marks this as the normal DNN and not the LADN DNN, as the associated LADN DNN and S-NSSAI are removed from the extended LADN information. The UE 100 may decide to keep or release the PDU session.

In an embodiment shown herein, based on the update received in the UE configuration update procedure, the UE 100 considers or marks this as the normal DNN and not the LADN DNN, because the associated LADN DNN is removed from the extended LADN information. The UE 100 may decide to keep or release the PDU session.

In an embodiment shown herein, on receiving the Nsmf_PDUSession_UpdateSMContext service operation from the AMF 700 that this PDU is not subjected to LADN per DNN and S-NSSAI for the existing PDU session of associated DNN and S-NSSAI, the SMF 800 may decide to keep or release the PDU based on the operator policy.

Embodiments herein use the Nsmf_PDUSession_UpdateSMContext service operation as an example of a message or service operation that the AMF 700 can use to indicate the information/indication that the respective PDU session/DNN is not LADN DNN.

In an embodiment shown herein, based on any message or service operation, the AMF 700 indicates in the information that the respective PDU session/DNN is not LADN DNN and that the SMF 800 releases the PDU session, but this can be any NF in the network. For example, on determining that the respective PDU session is no longer a LADN DNN, the AMF 700 can trigger the release of the PDU session (for example, by setting PDU session status information element (IE) as INACTIVE and indicating to the UE). This makes the UE 100 release the PDU session or can request the SMF 800 to release the PDU session by invoking the respective service operation. For example, the Nsmf_PDUSession_release makes the SMF 800 to release the PDU session.

The terms “LADN information” and “extended LADN information” are used interchangeably herein, where the LADN information generally refers to LADN per DNN and service area, and the extended LADN information refers to LADN per DNN and S-NSSAI, and service area.

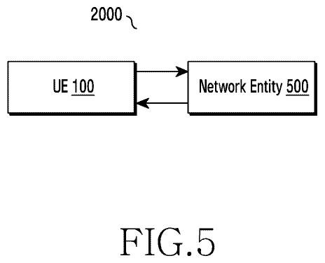

FIG. 5 illustrates an overview of the wireless network 2000 for handling at least one protocol data unit (PDU) session. In an embodiment, the wireless network 2000 includes the UE 100 and a network entity 500. The network entity 500 can be, for example, but is not limited to, the AMF 700 and the SMF entity 800. The wireless network 2000 can be, for example, but is not limited to, a 4G network, a 5G network, a 6G network, an open radio access network (ORAN) network, or any other 3GPP network. The UE 100 can be, for example, but not limited to, a laptop, a desktop computer, a notebook, a device-to-device (D2D) device, a vehicle-to-everything (V2X) device, a smartphone, a foldable phone, a smart TV, a tablet, an immersive device, an Internet of Things (IoT) device, and any other device capable of communicating using at least one 3GPP network.

The UE 100 handles at least one protocol data unit (PDU) session in the wireless network 2000. The UE 100 sends the registration request with S-NSSAI1, S-NSSAI2, and S-NSSAI3 and indicates the support for LADN per DNN and S-NSSAI. The AMF 700 is configured as DNN1, and S-NSSAI 1 and DNN2, and S-NSSAI2 as LADN DNN per DNN and S-NSSAI. A LADN service area TA1, TA2 is configured locally at AMF 700 or may be received from UDM for both LADN. In response to sending the registration request to the AMF: DNN1 and S-NSSAI1, TA1, TA2, and DNN2, S-NSSAI2, TA1, TA2, the UE 100 receives the extended LADN information from the AMF 700. The UE 100 has an established PDU session (PDU1), which is done using DNN3 and S-NSSAI3. Consider that there is an update to the extended LADN information (such as, but not limited to, the addition of DNN3 and S-NSSAI3). The UE 100 receives the updated extended LADN information from the AMF 700 using the UE configuration update procedure: (DNN1 and S-NSSAI1, TA1, TA2), (DNN2, and S-NSSAI2, TA1, TA2), and (DNN3, and S-NSSAI3, TA1, TA2). The AMF 700 sends the Nsmf_PDUSession_UpdateSMContext service operation and indicates that the PDU is subjected to the LADN per DNN and S-NSSAI or that the PDU is subjected to the LADN per DNN and S-NSSAI is enabled. Based on the received indication, the SMF 800 considers or marks the PDU as LADN DNN. The SMF 800 subscribes the AMF 700 to the “UE mobility event notification” service by sending Namf_EventExposure_Subscribe service operation.

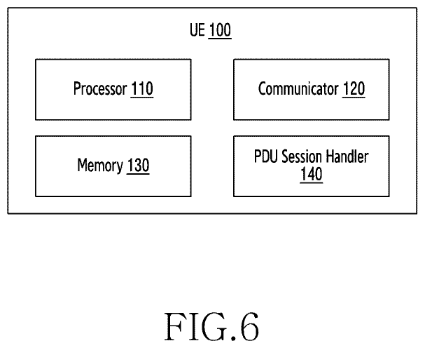

FIG. 6 illustrates various hardware components of the UE 100 for handling at least one protocol data unit (PDU) session in a wireless network 2000. In the embodiment shown herein, the UE 100 is communicated to the network entity 500, both the UE 100 and the network entity 500 include a memory 130, a processor 110, a communicator 120, and a PDU session handler 140. The processor (110) is coupled with the communicator (120), the memory (130) and a PDU session handler (140).

The memory 130 is configured to store instructions to be executed by the processor. The memory 130 can include non-volatile storage elements. Examples of such non-volatile storage elements may include magnetic hard disks, optical disks, floppy disks, flash memories, or forms of electrically programmable memories (EPROM) or electrically erasable and programmable (EEPROM) memories. In addition, the memory 130 may, in some examples, be considered a non-transitory storage medium. The term “non-transitory” may indicate that the storage medium is not embodied in a carrier wave or a propagated signal. However, the term “non-transitory” should not be interpreted that the memory 130 is non-movable. In some examples, the memory 130 is configured to store larger amounts of information. In certain examples, a non-transitory storage medium may store data that can, over time, change (e.g., in random access memory (RAM) or cache).

The processor 110 may include one or a plurality of processors. The one or the plurality of processors may be a general-purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU). The processor 110 may include multiple cores and is configured to execute the instructions stored in the memory 130.

In an embodiment shown herein, the communicator 120 includes an electronic circuit specific to a standard that enables wired or wireless communication. The communicator 120 is configured to communicate internally between internal hardware components of the UE 100 and with external devices via one or more networks.

In an embodiment, the PDU session handler 140 can handle existing PDU sessions upon LADN information being updated. The PDU session handler 140 can be physically implemented by analog or digital circuits such as logic gates, integrated circuits, microprocessors, microcontrollers, memory circuits, passive electronic components, active electronic components, optical components, hardwired circuits, or the like, and may optionally be driven by firmware. The PDU session handler 140 can receive the update to at least one extended LADN information using the UE configuration update procedure received from the AMF, comprising one of, addition and removal of the at least one associated set of DNN, S-NSSAI and SA for the at least one ongoing PDU session.

Further, the PDU session handler 140 can determine one of, keeping at least one PDU session based on the received update from the UE configuration update procedure, and releasing at least one ongoing PDU session locally based on the received update from the UE configuration update procedure.

Although FIG. 6 illustrates various hardware components of the UE 100, but it is to be understood that other embodiments are not limited thereto. In other embodiments, the UE 100 may include less or more components. Further, the labels or names of the components are used only for illustrative purposes and do not limit the scope of the disclosure. One or more components can be combined to perform the same or substantially similar function in the UE 100.

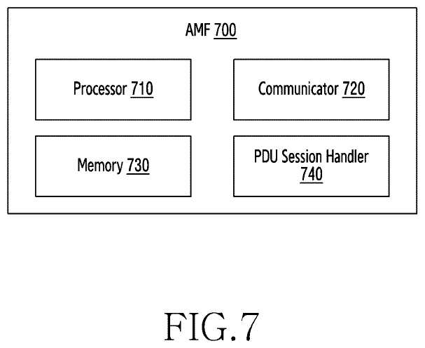

FIG. 7 illustrates various hardware components of the AMF 700, according to embodiments as disclosed herein. The AMF 700 includes a processor 710, a communicator 720, a memory 730 and a PDU session handler 740. The processor 710 is coupled with the communicator 720, the memory 730 and the PDU session handler 740.

The PDU session handler 740 can identify the update to at least one extended LADN information for at least one ongoing PDU session. Further, the PDU session handler 740 can determine the identified update to the at least one extended LADN information comprises one of, addition and removal of at least one associated set of DNN, S-NSSAI and SA for at least one ongoing PDU session. Further, the PDU session handler 740 can send a service operation message to the SMF 800 based on the determined update to release at least one ongoing PDU session along with a release indication. The service operation message sent by the AMF 700 to the SMF 800 is Nsmf_PDUSession_UpdateSMContext message. The release indication indicates one of, addition and removal of the at least one associated set of DNN, S-NSSAI and SA for the at least one ongoing PDU session.

Further, the PDU session handler 740 can identify the update to at least one extended LADN information based on one of, a local configuration update at the AMF 700 or based on a notification received from a UDM.

The SMF 800 sends the PDU session release message to the UE 100 with a cause code. The cause code comprises the release indication information received by the SMF 800 from the AMF 700.

Further, the PDU session handler 740 can trigger the release of the at least one ongoing PDU session by setting PDU sessions status IE as INACTIVE indicating to the UE 100 to release at least one ongoing PDU session. Thus, the UE 100 performs one of, release at least one ongoing PDU session locally and send a request to the SMF 800 to release the at least one PDU session.

The PDU session handler 740 is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor 710 is configured to execute instructions stored in the memory 730 and to perform various processes. The communicator 720 is configured for communicating internally between internal hardware components and with external devices via one or more networks. The memory 730 also stores instructions to be executed by the processor 710. The memory 730 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 730 may, in some examples, be considered a non-transitory storage medium. The term “non-transitory” may indicate that the storage medium is not embodied in a carrier wave or a propagated signal. However, the term “non-transitory” should not be interpreted that the memory 730 is non-movable. In certain examples, a non-transitory storage medium may store data that can, over time, change (e.g., in random access memory (RAM) or cache).

Further, at least one of the pluralities of modules/handler may be implemented through the AI model. A function associated with the AI model may be performed through the non-volatile memory, the volatile memory, and the processor 710. The processor 710 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although the FIG. 7 shows various hardware components of the AMF 700, but it is to be understood that other embodiments are not limited thereon. In other embodiments, the AMF 700 may include less or more number of components. Further, the labels or names of the components are used only for illustrative purpose and does not limit the scope of the disclosure. One or more components can be combined together to perform same or substantially similar function in the AMF 700.

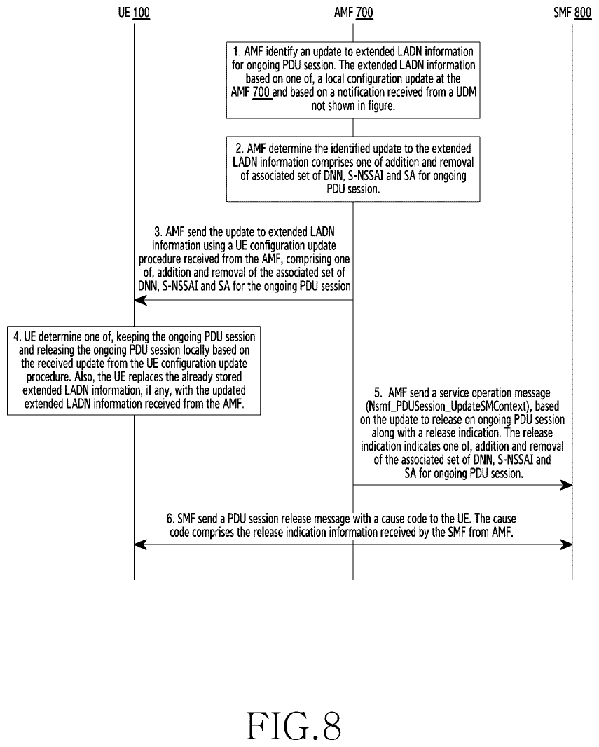

FIG. 8 illustrates a sequence diagram of a method for handling the LADN PDU session in the wireless network 2000. Referring to FIG. 8, at step 1, the AMF 700 identifies the update to at least one extended LADN information for at least one ongoing PDU session. The update to at least one extended LADN information based on one of, a local configuration update at the AMF 700 and based on a notification received from the UDM (not shown in figure). At step 2, the AMF 700 determines the identified update to at least one extended LADN information comprises one of, addition and removal of at least one associated set of DNN, S-NSSAI and SA for at least one ongoing PDU session. At step 3, the AMF 700 sends the update to at least one extended LADN information using a UE configuration update procedure received from the AMF (700), comprising one of, addition and removal of the at least one associated set of DNN, S-NSSAI and SA for at least one ongoing PDU session. At step 4, the UE 100 determines one of, keeping at least one ongoing PDU session and releasing at least one ongoing PDU session locally based on the received update from the UE configuration update procedure.

Also, the UE 100 replaces the already stored extended LADN information, if any, with the updated extended LADN information received from the AMF 700. At step 5, the AMF 700 sends the service operation message to the SMF 800 based on the determined update to release at least one ongoing PDU session along with a release indication. The release indication indicates one of, addition and removal of the at least one associated set of DNN, S-NSSAI and SA for at least one ongoing PDU session. The service operation message sent by the AMF 700 to the SMF 800 is Nsmf_PDUSession_UpdateSMContext message. At step 6, the SMF 800 sends a PDU session release message to a UE 100 with a cause code. The cause code comprises the release indication information received by the SMF 800 from the AMF 700.

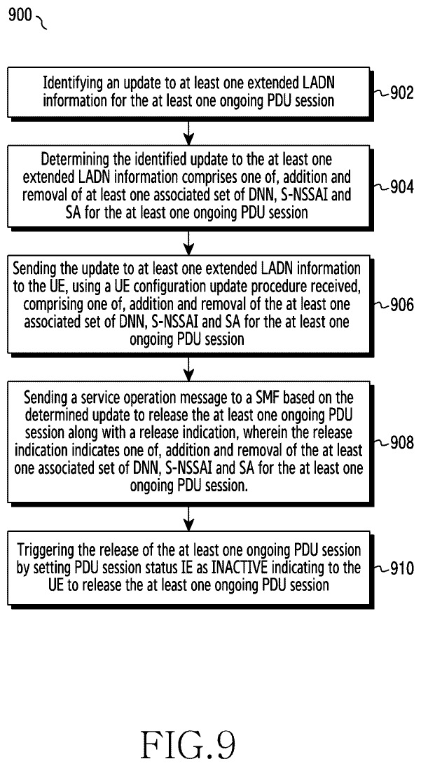

FIG. 9 illustrates a flowchart of a method 900 for handling at least one PDU session in a wireless network 2000. The operations (902-910) are handled by the AMF 700. At step 902, the method discloses identifying the update to at least one extended local area data network (LADN) information for the at least one ongoing PDU session. The AMF 700 identifies the update to at least one extended LADN information based on one of, a local configuration update at the AMF 700 or based on a notification received from a UDM. At step 904, the method discloses determining the identified update to the at least one extended LADN information comprises one of, addition and removal of at least one associated set of DNN, S-NSSAI and SA for the at least one ongoing PDU session. At step 906, the method discloses sending the update to at least one extended LADN information using the UE configuration update procedure received to the UE 100, comprising one of, addition and removal of the at least one associated set of DNN, S-NSSAI and SA for the at least one ongoing PDU session. At step 908, the method discloses sending the service operation message to the SMF 800 based on the determined update to release the at least one ongoing PDU session along with a release indication.

The service operation message sent by the AMF 700 to the SMF 800 is Nsmf_PDUSession_UpdateSMContext message. The release indication indicates one of, addition and removal of the at least one associated set of DNN, S-NSSAI and SA for at least one ongoing PDU session. The SMF 800 sends a PDU session release message to the UE 100 with the cause code. The cause code comprises the release indication information received by the SMF 800 from the AMF 700. At step 910, the method discloses triggering the release of the at least one ongoing PDU session by setting PDU sessions status IE as INACTIVE indicating to the UE 100 to release the at least one ongoing PDU session. The UE 100 performs one of, release the at least one ongoing PDU session locally and send a request to the SMF 800 to release the at least one PDU session.

The various actions in method 900 may be performed in the order presented, in a different order, or simultaneously. Further, in some embodiments, some actions listed in FIG. 9 may be omitted.

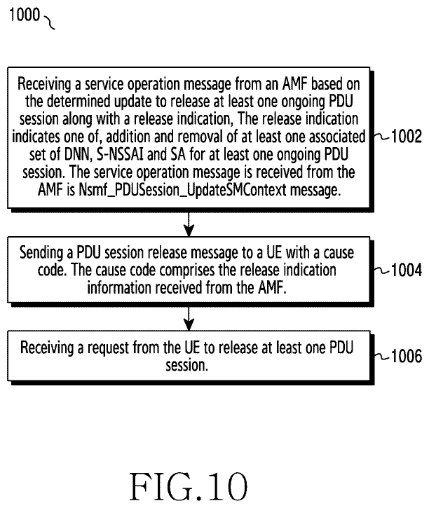

FIG. 10 illustrates a flowchart of a method 1000 for handling at least one PDU session in a wireless network 2000. The operations (1002-1006) are handled by the SMF 800. At step 1002, the method discloses receiving the service operation message from the AMF 700 based on the determined update to release the at least one ongoing PDU session along with the release indication. The release indication indicates one of, addition and removal of at least one associated set of DNN, S-NSSAI and SA for at least one ongoing PDU session. The service operation message is received from the AMF 700 is Nsmf_PDUSession_UpdateSMContext message. At step 1004, the method discloses sending the PDU session release message to the UE 100 with the cause code. The cause code comprises the release indication information received from the AMF 700. At step 1006, the method discloses receiving the request from the UE 100 to release at least one PDU session.

The various actions in method 1000 may be performed in the order presented, in a different order, or simultaneously. Further, in some embodiments, some actions listed in FIG. 10 may be omitted.

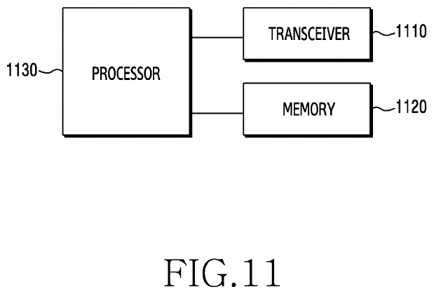

FIG. 11 illustrates various hardware components of a network entity according to the embodiments as disclosed herein.

Referring to FIG. 11, the network entity includes a transceiver (1110), a memory (1120), and a processor (1130). The transceiver (1110), the memory (1120), and the processor (1130) of the network entity may operate according to a communication method of the network entity described above. Furthermore, the network entity of FIG. 11 corresponds to the network entity (500) of the FIG. 5.

However, the components of the terminal are not limited thereto. For example, the network entity may include fewer or a greater number of components than those described above. However, the components of the network entity are not limited thereto. For example, the network entity may include more or fewer components than those described above. In addition, the processor (1130), the transceiver (1110), and the memory (1120) may be implemented as a single chip. Also, the processor (1130) may include at least one processor.

The network entity includes at least one entity of a core network. For example, the network entity includes an AMF, a session management function (SMF), a policy control function (PCF), a network repository function (NRF), a user plane function (UPF), a network slicing selection function (NSSF), an authentication server function (AUSF), a UDM and a network exposure function (NEF), but the network entity is not limited thereto.

The transceiver (1110) collectively refers to a network entity receiver and a network entity transmitter, and may transmit/receive a signal to/from a base station or a UE. The signal transmitted or received to or from the base station or the UE may include control information and data. In this regard, the transceiver (1110) may include an RF transmitter for up-converting and amplifying a frequency of a transmitted signal, and an RF receiver for amplifying low-noise and down-converting a frequency of a received signal. However, this is only an example of the transceiver (1110) and components of the transceiver (1110) are not limited to the RF transmitter and the RF receiver.

The transceiver (1110) may receive and output, to the processor (1130), a signal through a wireless channel, and transmit a signal output from the processor (1130) through the wireless channel.

The memory (1120) may store a program and data required for operations of the network entity. Also, the memory (1120) may store control information or data included in a signal obtained by the network entity. The memory (1120) may be a storage medium, such as a ROM, a RAM, a hard disk, a CD-ROM, and a DVD, or a combination of storage media.

The processor (1130) may control a series of processes such that the network entity operates as described above. For example, the transceiver (1110) may receive a data signal including a control signal, and the processor (1130) may determine a result of receiving the data signal.

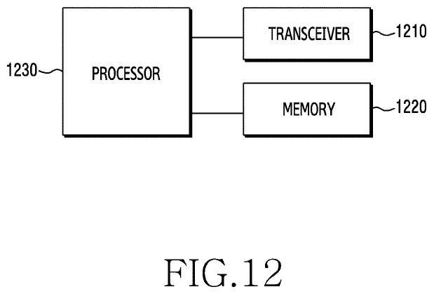

FIG. 12 illustrates a structure of a base station according to an embodiment of the disclosure.

As shown in FIG. 12, the base station according to an embodiment may include a transceiver 1210, a memory 1220, and a processor 1230. The transceiver 1210, the memory 1220, and the processor 1230 of the base station may operate according to a communication method of the base station described above. However, the components of the base station are not limited thereto. For example, the base station may include more or fewer components than those described above. In addition, the processor 1230, the transceiver 1210, and the memory 1220 may be implemented as a single chip. Also, the processor 1230 may include at least one processor.

The transceiver 1210 collectively refers to a base station receiver and a base station transmitter, and may transmit/receive a signal to/from a terminal (UE) or a network entity. The signal transmitted or received to or from the terminal or a network entity may include control information and data. The transceiver 1210 may include a RF transmitter for up-converting and amplifying a frequency of a transmitted signal, and a RF receiver for amplifying low-noise and down-converting a frequency of a received signal. However, this is only an example of the transceiver 1210 and components of the transceiver 1210 are not limited to the RF transmitter and the RF receiver.

Also, the transceiver 1210 may receive and output, to the processor 1230, a signal through a wireless channel, and transmit a signal output from the processor 1230 through the wireless channel.

The memory 1220 may store a program and data required for operations of the base station. Also, the memory 1220 may store control information or data included in a signal obtained by the base station. The memory 1220 may be a storage medium, such as read-only memory (ROM), random access memory (RAM), a hard disk, a CD-ROM, and a DVD, or a combination of storage media.

The processor 1230 may control a series of processes such that the base station operates as described above. For example, the transceiver 1210 may receive a data signal including a control signal transmitted by the terminal, and the processor 1230 may determine a result of receiving the control signal and the data signal transmitted by the terminal.

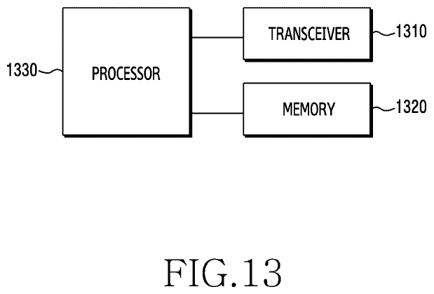

FIG. 13 illustrates a structure of a UE according to an embodiment of the disclosure.

As shown in FIG. 13, the UE according to an embodiment may include a transceiver 1310, a memory 1320, and a processor 1330. The transceiver 1310, the memory 1320, and the processor 1330 of the UE may operate according to a communication method of the UE described above. However, the components of the UE are not limited thereto. For example, the UE may include more or fewer components than those described above. In addition, the processor 1330, the transceiver 1310, and the memory 1320 may be implemented as a single chip. Also, the processor 1330 may include at least one processor. Furthermore, the UE of FIG. 13 corresponds to the UE of the FIG. 6.

The transceiver 1310 collectively refers to a UE receiver and a UE transmitter, and may transmit/receive a signal to/from a base station or a network entity. The signal transmitted or received to or from the base station or a network entity may include control information and data. The transceiver 1310 may include a RF transmitter for up-converting and amplifying a frequency of a transmitted signal, and a RF receiver for amplifying low-noise and down-converting a frequency of a received signal. However, this is only an example of the transceiver 1310 and components of the transceiver 1310 are not limited to the RF transmitter and the RF receiver.

Also, the transceiver 1310 may receive and output, to the processor 1330, a signal through a wireless channel, and transmit a signal output from the processor 1330 through the wireless channel.

The memory 1320 may store a program and data required for operations of the UE. Also, the memory 1320 may store control information or data included in a signal obtained by the UE. The memory 1320 may be a storage medium, such as read-only memory (ROM), random access memory (RAM), a hard disk, a CD-ROM, and a DVD, or a combination of storage media.

The processor 1330 may control a series of processes such that the UE operates as described above. For example, the transceiver 1310 may receive a data signal including a control signal transmitted by the base station or the network entity, and the processor 1330 may determine a result of receiving the control signal and the data signal transmitted by the base station or the network entity.

The embodiments disclosed herein can be implemented through at least one software program running on at least one hardware device and performing network management functions to control the elements. The elements can be at least one of a hardware devices, or a combination of hardware device and software module.

The embodiment disclosed herein describes a device and methods for handling at least one PDU session in a wireless network 2000. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., very high speed integrated circuit hardware description language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the disclosure may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by an access and mobility management function (AMF) entity in a wireless communication system, the method comprising:
identifying whether a first local area data network (LADN) service area for a data network name (DNN) and single-network slice selection assistance information (S-NSSAI) is removed; and
transmitting, to a session management function (SMF) entity, a message for requesting a release of an ongoing protocol data unit (PDU) session subjected to an LADN in case that the first LADN service area is removed.

2. The method of claim 1, wherein whether the first LADN service area is removed is identified based on a notification from a unified data management (UDM) entity or a local configuration update.

3. The method of claim 1, wherein the ongoing PDU session is released based on a Nsmf_PDUSession_UpdateSMContext service operation.

4. The method of claim 1, wherein the LADN is configured per LADN DNN and S-NSSAI associated with the DNN and S-NSSAI.

5. The method of claim 1, further comprising:
identifying whether a second LADN service area for a DNN and S-NSSAI is configured,
wherein the message is transmitted in case that the second LADN service area is configured.

6. A method performed by a session management function (SMF) entity in a wireless communication system, the method comprising:
receiving, from an access and mobility management function (AMF) entity, a message for requesting a release of an ongoing protocol data unit (PDU) session subjected to a local area data network (LADN) in case that a first LADN service area is removed,
wherein the first LADN service area is fora data network name (DNN) and single-network slice selection assistance information (S-NSSAI).

7. The method of claim 6, wherein whether the first LADN service area is removed is based on a notification from a unified data management (UDM) entity or a local configuration update.

8. The method of claim 6, wherein the ongoing PDU session is released based on a Nsmf_PDUSession_UpdateSMContext service operation.

9. The method of claim 6, wherein the LADN is configured per LADN DNN and S-NSSAI associated with the DNN and S-NSSAI.

10. The method of claim 6, wherein the message is received in case that a second LADN service area for a DNN and S-NSSAI is configured.

11. An access and mobility management function (AMF) entity in a wireless communication system, the AMF comprising:
a transceiver; and
at least one processor coupled with the transceiver and configured to:
identify whether a first local area data network (LADN) service area for a data network name (DNN) and single-network slice selection assistance information (S-NSSAI) is removed, and
transmit, to a session management function (SMF) entity, a message for requesting a release of an ongoing protocol data unit (PDU) session subjected to an LADN in case that the first LADN service area is removed.

12. The AMF entity of claim 11, wherein whether the first LADN service area is removed is identified based on a notification from a unified data management (UDM) entity or a local configuration update.

13. The AMF entity of claim 11, wherein the ongoing PDU session is released based on a Nsmf_PDUSession_UpdateSMContext service operation.

14. The AMF entity of claim 11, wherein the LADN is configured per LADN DNN and S-NSSAI associated with the DNN and S-NSSAI.

15. The AMF entity of claim 11, wherein the at least one processor is further configured to:
identify whether a second LADN service area for a DNN and S-NSSAI is configured, and
wherein the message is transmitted in case that the second LADN service area is configured.

16. A session management function (SMF) entity in a wireless communication system, the SMF comprising:
a transceiver; and
at least one processor coupled with the transceiver and configured to:
receive, from an access and mobility management function (AMF) entity, a message for requesting a release of an ongoing protocol data unit (PDU) session subjected to a local area data network (LADN) in case that a first LADN service area is removed,
wherein the first LADN service area is for a data network name (DNN) and single-network slice selection assistance information (S-NSSAI).

17. The SMF entity of claim 16, wherein whether the first LADN service area is removed is based on a notification from a unified data management (UDM) entity or a local configuration update.

18. The SMF entity of claim 16, wherein the ongoing PDU session is released based on a Nsmf_PDUSession_UpdateSMContext service operation.

19. The SMF entity of claim 16, wherein the LADN is configured per an LADN DNN and S-NSSAI associated with the DNN and S-NSSAI.

20. The SMF entity of claim 16, wherein the message is received in case that a second LADN service area for a DNN and S-NSSAI is configured.
